(19) United States
(12) Patent Application Publication
(10) Pub. No.: US 2026/0161466 A1
(43) Pub. Date: Jun. 11, 2026

(54) Memory-Resident Execution of Persistent Executable Objects In Distributed Computing Systems

(71) Applicant: Nicholas Clark, Thetford Center, VT (US)

(72) Inventor: Nicholas Clark, Thetford Center, VT (US)

(21) Appl. No.: 19/538,221

(22) Filed: Feb. 12, 2026

Related U.S. Application Data
(60) Provisional application No. 63/789,967, filed on Apr. 16, 2025.
(60) Provisional application No. 63/800,515, filed on May 6, 2025.

(51) Int. Cl. G06F 9/50

(52) U.S. Cl. CPC G06F 9/5027

(57) ABSTRACT

A computer-implemented method and system for executing semantic computation in distributed computing environments. Each computational task is instantiated as a persistent executable object comprising an intent field, a context block, and a memory field that stores execution history. The persistent executable object propagates among execution nodes, each of which independently evaluates the object based on embedded intent, context, memory, and locally applied policy. Execution actions including execution, mutation, delegation, dormancy, reentry, and termination are determined without centralized orchestration. Execution outcomes are appended to the memory field, enabling execution continuity across asynchronous execution cycles. Compositional delegation, policy-bound evaluation, and memory-resident execution state enable adaptive, distributed execution across heterogeneous environments without reliance on external schedulers, centralized controllers, or session-bound runtime state.

### RELATED APPLICATION DATA

This application claims the benefit of priority of U.S. Provisional Patent Applications Ser. No. 63/789,967, filed on Apr. 16, 2025, titled “Cross-Domain Applications of the Adaptive Query Framework” and Application Ser. No. 63/800,515, filed on May 6, 2025, titled “Cognition-Native Semantic Execution Platform for Distributed, Stateful, and Ethically-Constrained Agent Systems”, each of which is incorporated by reference herein in its entirety.

### FIELD

The present invention relates generally to distributed computing systems and execution frameworks for computational tasks. In particular, it relates to memory-resident execution of persistent executable objects in distributed computing systems and methods thereof.

### BACKGROUND

Conventional computing systems execute tasks as ephemeral processes whose execution state is maintained externally by runtimes, schedulers, orchestration layers, or session-bound control mechanisms. Such systems typically require execution context, progress, and decision logic to be reconstructed at each invocation or managed through centralized workflow engines, resulting in tightly coupled execution paths that are difficult to persist, resume, or distribute across heterogeneous environments.

In distributed and cloud-based architectures, execution is commonly implemented through stateless calls coordinated by external controllers that track progress, retries, and failure handling. These approaches require separate orchestration logic to manage long-running or adaptive tasks, increasing system complexity and introducing points of failure when execution spans asynchronous systems, disconnected environments, or trust-divergent domains.

Artificial intelligence and probabilistic inference engine-based systems often treat execution as a sequence of prompt-response interactions or tool invocations governed by external control logic. Execution decisions, task progression, and adaptation are typically handled outside the data structures being processed, requiring repeated rehydration of context and limiting the ability of computational objects to persist execution intent, history, or governance across time.

Existing automation frameworks such as workflow engines, business process management systems, rules engines, or smart-contract mechanisms rely on predefined task graphs, transactional state transitions, or globally consistent execution rules. Such systems typically assume deterministic progression, discrete completion events, and externally managed execution state.

Accordingly, there is a need for systems and methods that address these shortcomings.

### SUMMARY OF THE DISCLOSURE

A method for executing semantic object-resident computation in a distributed computing system includes instantiating a persistent executable object stored in non-transitory memory, the persistent executable object comprising an intent field encoding a machine-readable execution descriptor, a context block encoding execution-relevant metadata, and a memory field encoding prior execution state, propagating the persistent executable object among a plurality of execution nodes of the distributed computing system, and, at each execution node that receives the persistent executable object, performing an execution evaluation cycle. The execution evaluation cycle includes parsing the intent field to identify an execution operation expressed by the machine-readable execution descriptor, evaluating the context block against locally applicable execution policy without reliance on centralized coordination, reading the memory field to retrieve one or more prior execution records stored by a previous execution evaluation cycle, and selecting, based solely on the parsed intent field, the evaluated context block, and the retrieved prior execution records, an execution action selected from the group consisting of execution, mutation, delegation, dormancy, reentry, and termination. The method also includes executing the selected execution action and recording an execution outcome corresponding to the selected execution action by appending a new execution record to the memory field of the persistent executable object. Execution continuity across multiple execution lifecycles is maintained by the memory field of the persistent executable object.

A distributed computing system includes a plurality of execution nodes and a persistent execution object configured to propagate among the execution nodes. The persistent execution object includes an intent field encoding a machine-readable execution descriptor, a context block encoding execution-relevant metadata, and a memory field storing an append-only execution history. Each execution node is configured to parse the intent field, evaluate the context block, and read the memory field, select an execution action as a function of data stored within the intent field, the context block, and the memory field without centralized coordination, and append an execution outcome corresponding to the selected execution action to the memory field, such that execution continuity of the persistent executable object is preserved by the object-resident execution state.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 illustrates a distributed semantic execution architecture in which persistent semantic objects are executed across heterogeneous nodes without centralized orchestration, in accordance with an embodiment of the present disclosure;

FIG. 2 illustrates an internal structure of a persistent semantic object comprising an intent field, a context block, and a memory field used to maintain execution state across execution cycles, in accordance with an embodiment of the present disclosure;

FIG. 3 illustrates a lifecycle of a persistent semantic object including instantiation, execution evaluation, mutation, delegation, dormancy, reentry, and termination, in accordance with an embodiment of the present disclosure;

FIG. 4 illustrates adaptive execution behavior in which a persistent semantic object modifies its execution behavior based on execution outcomes or environmental feedback, in accordance with an embodiment of the present disclosure;

FIG. 5 illustrates compositional execution through recursive delegation of persistent semantic objects forming a distributed execution graph, in accordance with an embodiment of the present disclosure; and

FIG. 6 illustrates policy-bound execution behavior including dormancy and reentry of a persistent semantic object based on execution conditions and policy evaluation, in accordance with an embodiment of the present disclosure.

### DETAILED DESCRIPTION

### 1. Overview of the Adaptive Query Execution Layer

Existing execution models do not provide a mechanism by which a computational object itself can carry execution state, decision history, and eligibility conditions as an intrinsic property of the object, independent of any specific runtime, scheduler, or orchestration engine. As a result, these systems lack a unified way to support persistent, adaptive execution that can evolve over time, resume after interruption, or respond to environmental feedback without centralized control. The distributed semantic execution techniques disclosed herein provide a unified way to support persistent, adaptive execution that can evolve over time, resume after interruption, and respond to environmental feedback without centralized control.

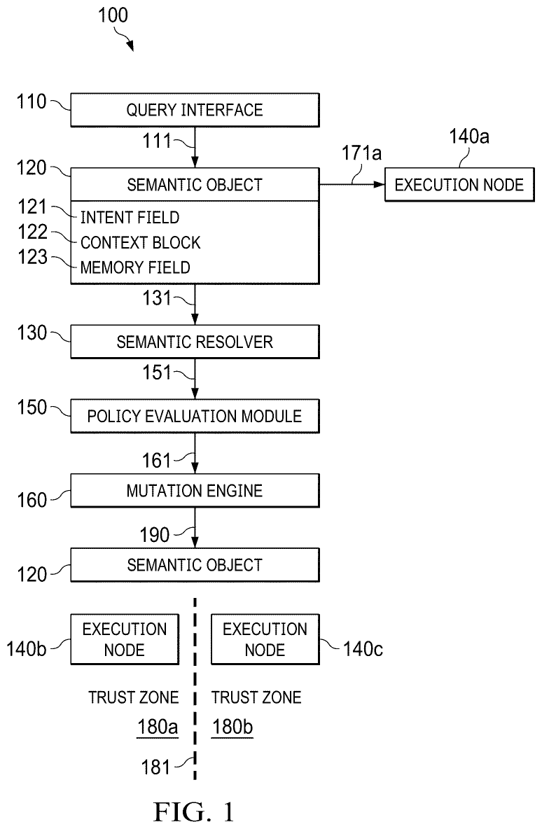

FIG. 1 illustrates a distributed semantic execution architecture 100 in accordance with an embodiment of the present disclosure. The architecture 100 defines an execution framework in which execution state is carried within persistent executable semantic objects rather than maintained by external runtimes, schedulers, or centralized orchestration systems.

The architecture 100 includes a query interface 110. The query interface 110 is configured to instantiate a semantic object 120. An arrow 111 represents emission of the semantic object 120 from the query interface 110 into the execution environment.

The semantic object 120 is a persistent, memory-resident execution object. The semantic object 120 comprises an intent field 121, a context block 122, and a memory field 123. The intent field 121 represents a semantic objective (execution descriptor) associated with the semantic object 120. The context block 122 represents identity metadata, trust scope information, and execution context associated with the semantic object 120. The memory field 123 stores execution traces, mutation records, delegation references, and policy outcomes accumulated during execution.

The semantic object 120 is provided to a semantic resolver 130. An arrow 131 represents interpretation of the semantic object 120 by the semantic resolver 130. The semantic resolver 130 parses the intent field 121, the context block 122, and the memory field 123 to determine an execution response based on data embedded within the semantic object 120.

The architecture 100 further includes a policy evaluation module 150. An arrow 151 represents evaluation of embedded policy references within the semantic object 120 by the policy evaluation module 150. The policy evaluation module 150 determines whether execution, deferral, mutation, delegation, or rejection is appropriate based on locally applied policy criteria.

In some embodiments, evaluation of the context block against locally applicable execution policy comprises assessing one or more execution eligibility conditions specific to an execution node, without reliance on centralized coordination or global scheduling. Such execution eligibility conditions may include, without limitation, resource sufficiency constraints of the execution node, sandbox or isolation constraints applicable to the semantic object, rate-limit or cooldown conditions governing permissible execution frequency, and retry or attempt thresholds derived from prior execution records stored within the memory field.

In certain embodiments, locally applicable execution policy evaluates whether available compute capacity, memory availability, execution time windows, or isolation requirements permit immediate execution of an authorized action. Where such conditions are not satisfied, the execution node may select a dormancy action, defer execution, or terminate the semantic object, notwithstanding that a different execution node operating under a different local policy may select a different action for the same semantic object.

In some embodiments, locally applicable execution policy further evaluates execution history recorded within the memory field, including prior failures, retry counts, elapsed time since a prior execution attempt, or recorded execution outcomes, to determine whether execution, reentry from dormancy, delegation, or termination is permitted. For example, an execution node may transition the semantic object to a dormant state upon exceeding a retry budget, or may terminate the semantic object upon satisfaction of a terminal condition recorded within the memory field.

In this manner, heterogeneous execution nodes operating within different trust zones, resource environments, or policy regimes may lawfully select different execution actions for the same semantic object, while preserving execution continuity, auditability, and object-resident state consistency through the append-only recording of all execution decisions and resulting state transitions within the memory field.

In some embodiments, cognition is performed by a semantic resolver, inference engine, or probabilistic model that evaluates the semantic object and produces a recommended execution action or interpretation. Such cognitive output is advisory in nature and does not itself modify the semantic object or authorize execution. Cognitive outputs are treated as inputs to policy evaluation or execution evaluation rather than as binding decisions. By separating cognition from authority, the execution layer prevents reasoning components from unilaterally mutating execution state, granting permissions, or bypassing policy constraints, even when such reasoning components generate high-confidence recommendations.

In accordance with the present disclosure, semantic execution is structured around an explicit separation between cognition, authority, and execution. Cognition refers to reasoning, inference, recommendation, or interpretation processes that may be applied to information carried by a semantic object. Authority refers to policy, governance, or trust constraints that determine whether and under what conditions execution actions are permitted. Execution refers to the concrete modification, propagation, dormancy, delegation, or termination of a semantic object as recorded within its memory field.

These roles are implemented as logically distinct functions that interact through the semantic object but do not collapse into a single decision-making entity. In particular, reasoning or inference processes do not themselves authorize execution, and policy evaluation does not itself perform execution. Execution actions are taken only when authorized outcomes are recorded and applied to the semantic object.

The architecture 100 further includes a mutation engine 160. An arrow 161 represents modification of the semantic object 120 by the mutation engine 160. The mutation engine 160 modifies at least one of the intent field 121, the context block 122, or the memory field 123 in response to execution outcomes or policy evaluation results.

An arrow 190 represents writing of execution outcomes and mutation records back into the memory field 123 of the semantic object 120. The semantic object 120 thereby retains execution continuity across execution cycles.

The semantic object 120 propagates to an execution node 140a. An arrow 171a represents propagation of the semantic object 120 to the execution node 140a. The execution node 140a performs execution actions based on evaluation of the semantic object 120 without reliance on centralized orchestration.

The architecture 100 further includes additional execution nodes 140b and 140c. Each execution node 140 independently evaluates the semantic object 120 when received.

Execution nodes 140 are associated with trust zones 180a and 180b. Trust zones 180 represent logical trust domains that constrain execution behavior and policy evaluation. A boundary 181 represents a trust boundary separating trust zone 180a from trust zone 180b. Execution nodes 140 within different trust zones 180 may reach different execution decisions when evaluating the same semantic object 120.

Unlike workflow engines, business process management systems, or smart-contract mechanisms that rely on predefined task graphs, transactional state transitions, or globally enforced execution rules, the execution model described herein operates on persistent, memory-resident semantic objects whose execution state evolves through mutation, delegation, dormancy, and reentry. Execution progression is not constrained to predefined workflows or contract logic, and execution state is not externalized to orchestration layers, schedulers, or ledgers. As a result, execution continuity is preserved through object-resident state rather than through process control structures or transactional enforcement. The distributed semantic execution architecture 100 operates without centralized control. Execution behavior emerges from repeated evaluation and modification of the semantic object 120 as it propagates across execution nodes 140, with continuity maintained through the memory field 123.

### 2. Agent Lifecycle and Execution Semantics

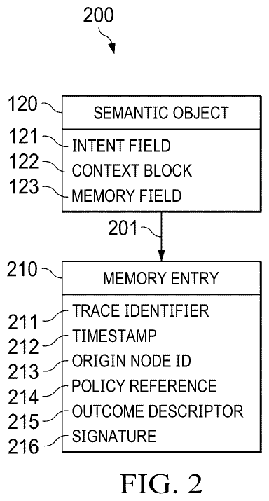

FIG. 2 illustrates an internal structure 200 of a semantic object 120 in accordance with an embodiment of the present disclosure. The internal structure 200 defines the components by which execution state, execution history, and execution outcomes are retained within the semantic object 120 during execution.

The semantic object 120 comprises an intent field 121, a context block 122, and a memory field 123. The intent field 121 represents a semantic objective associated with the semantic object 120. The context block 122 represents identity metadata, trust scope information, and execution context associated with the semantic object 120. The memory field 123 stores execution-related information accumulated during execution of the semantic object 120.

The memory field 123 comprises one or more memory entries 210. An arrow 201 represents the association between the memory field 123 and an individual memory entry 210. Each memory entry 210 records a discrete execution-related event.

Each memory entry 210 includes a trace identifier 211, a timestamp 212, an origin node identifier 213, a policy reference 214, an outcome descriptor 215, and a signature 216. The trace identifier 211 uniquely identifies the memory entry 210 within the memory field 123. The timestamp 212 records a temporal marker associated with the event. The origin node identifier 213 identifies the execution node that generated the memory entry 210. The policy reference 214 identifies a policy applied during evaluation or execution. The outcome descriptor 215 records the result of execution, mutation, delegation, dormancy, or reentry. The signature 216 provides cryptographic verification of the memory entry 210.

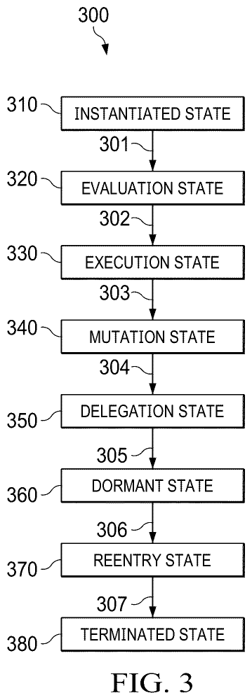

FIG. 3 illustrates a semantic execution lifecycle 300 of the semantic object 120 in accordance with an embodiment of the present disclosure. The lifecycle 300 defines execution as a progression through a plurality of execution states rather than as a single ephemeral process.

The lifecycle 300 begins at an instantiated state 310. The instantiated state 310 represents creation of the semantic object 120 with an intent field 121, a context block 122, and an initial memory field 123. A transition arrow 301 represents progression from the instantiated state 310 to an evaluation state 320.

Execution, as used herein, refers to transformation of the semantic object's state through mutation, delegation, dormancy, reentry, or termination, as recorded within the memory field. Execution does not encompass reasoning, interpretation, or policy determination, but is limited to state transitions applied to the semantic object following evaluation and authorization.

In some embodiments, execution proceeds without any cognitive reasoning, inference, or interpretation beyond evaluation of object-resident state. Execution behavior may be implemented as a deterministic or rule-based state machine operating solely on the intent field, context block, and memory field. In such embodiments, no probabilistic models, language models, or inference engines are required to achieve execution continuity.

By constraining execution to state transformation recorded within the semantic object, the execution layer maintains deterministic execution continuity independent of the mechanisms used to generate recommendations or authorization outcomes. As used herein, deterministic execution continuity refers to the deterministic preservation and serialization of execution state transitions within the semantic object, and does not require that the mechanisms producing such transitions be deterministic.

Execution may be deterministic or non-deterministic depending on the evaluation mechanisms applied by a given execution node. Regardless of whether execution behavior is deterministic, probabilistic, or otherwise variable across execution environments, all execution decisions and resulting state transitions are recorded within the memory field of the semantic object. In this manner, execution continuity and auditability are preserved independently of the determinism of any individual execution evaluation.

The evaluation state 320 represents interpretation of the semantic object 120 by an execution node. During the evaluation state 320, the execution node parses the intent field 121, the context block 122, and the memory field 123 to determine an execution response. A transition arrow 302 represents progression from the evaluation state 320 to an execution state 330.

The execution state 330 represents performance of an execution action based on the evaluated semantic object 120. Execution actions may include performing a computation, querying a resource, or interacting with an external system. A transition arrow 303 represents progression from the execution state 330 to a mutation state 340.

The mutation state 340 represents modification of the semantic object 120 based on execution outcomes or evaluation results. During the mutation state 340, at least one of the intent field 121, the context block 122, or the memory field 123 is modified. A transition arrow 304 represents progression from the mutation state 340 to a delegation state 350.

The delegation state 350 represents spawning of one or more subordinate semantic objects derived from the semantic object 120. During the delegation state 350, references to delegated semantic objects are recorded as memory entries 210 in the memory field 123. A transition arrow 305 represents progression from the delegation state 350 to a dormant state 360.

The dormant state 360 represents suspension of execution when execution conditions are unmet. During the dormant state 360, the semantic object 120 persists without active execution while retaining execution history in the memory field 123. A transition arrow 306 represents progression from the dormant state 360 to a reentry state 370.

The reentry state 370 represents resumption of execution when reentry conditions are satisfied. Reentry conditions may be derived from environmental signals, policy evaluation, or accumulated memory entries 210. A transition arrow 307 represents progression from the reentry state 370 to a terminated state 380.

The terminated state 380 represents completion or cessation of execution of the semantic object 120. Upon reaching the terminated state 380, no further execution actions are performed, and the semantic object 120 retains its final execution history within the memory field 123.

Execution progression through the lifecycle 300 is governed by information embedded within the semantic object 120 rather than by external schedulers or centralized control. Each transition represented by arrows 301-307 results in creation of at least one memory entry 210 appended to the memory field 123. The lifecycle 300 thereby defines execution as a memory-resident, stateful progression rather than as an ephemeral runtime event. Additional or fewer lifecycle states may be implemented without departing from the execution semantics described herein.

### 3. Intent Refinement and Semantic Mutation Behavior

During execution, the semantic object 120 may undergo controlled semantic mutation as a consequence of execution outcomes, policy evaluation, or accumulated execution history. Semantic mutation refers to modification of execution-relevant attributes of the semantic object 120 while preserving continuity of identity and execution lineage through the memory field 123.

The intent field 121 defines the semantic objective of the semantic object 120 at instantiation. The intent field 121 is not static and may be refined, constrained, expanded, or reclassified during execution based on information recorded in the memory field 123. Such refinement allows the semantic object 120 to adapt its execution behavior without terminating execution or requiring re-instantiation as a new object.

Semantic mutation is initiated during execution when an execution node determines that the current intent field 121 is partially satisfiable, over-scoped, under-specified, or misaligned with observed execution conditions. In response, the execution node modifies the intent field 121 to produce a refined intent that is more likely to yield successful execution under current constraints. The modification may include narrowing semantic scope, altering execution parameters, or re-expressing the objective in a different semantic classification.

Each semantic mutation is recorded as a memory entry 210 appended to the memory field 123. The memory entry records the prior intent state, the refined intent state, the justification for mutation, and the execution context under which the mutation occurred. This record preserves auditability and enables downstream execution nodes to reason about the evolution of the semantic object 120.

Mutation behavior is governed by policy references embedded within the semantic object 120. If a proposed mutation violates a policy constraint, the execution node may reject the mutation, defer execution, or initiate alternate execution behavior. Policy-governed mutation ensures that semantic evolution remains bounded by trust, scope, and governance constraints without reliance on external validation systems.

Semantic mutation does not require centralized orchestration or global state synchronization. Each execution node independently evaluates whether mutation is appropriate based on the memory field 123 and locally applied policy. As a result, semantic mutation may occur asynchronously and heterogeneously across execution nodes while preserving a consistent execution lineage.

Mutation behavior may also result in indirect execution changes, including modification of delegation parameters, adjustment of retry behavior, or preparation for subsequent execution states defined in the semantic execution lifecycle. However, mutation itself does not constitute delegation or routing and does not require spawning of subordinate semantic objects.

By enabling controlled refinement of the intent field 121 during execution, the semantic execution model supports adaptive execution that can respond to partial success, failure, or evolving system conditions. This capability differentiates semantic execution from fixed-form query models by allowing execution behavior to evolve over time while remaining memory-resident, policy-bound, and auditably traceable.

### 4. Compositional Execution and Recursive Lineage Graphs

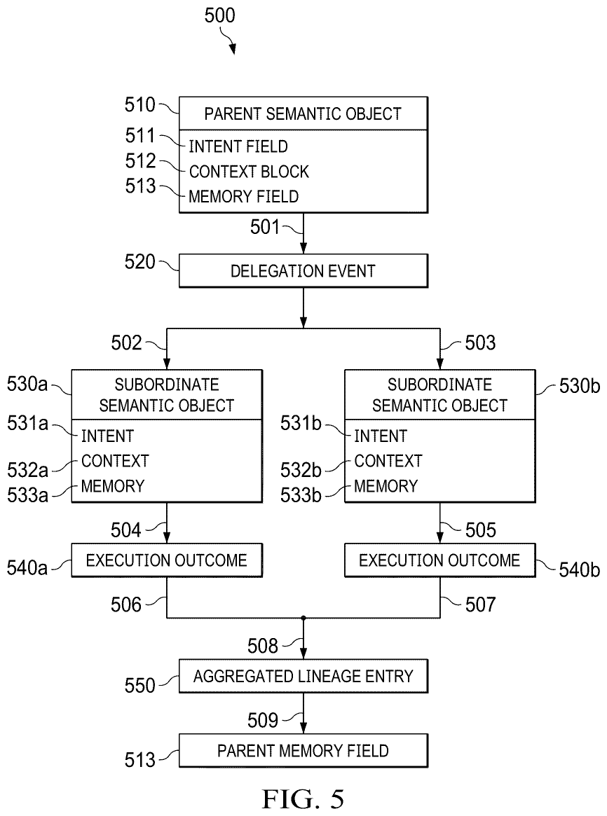

FIG. 5 illustrates a compositional semantic execution graph 500 in accordance with an embodiment of the present disclosure. The execution graph 500 represents recursive delegation of execution objectives across multiple persistent semantic objects while preserving execution lineage through memory-resident records.

The compositional execution graph 500 includes a parent semantic object 510. The parent semantic object 510 comprises an intent field 511, a context block 512, and a memory field 513. The intent field 511 represents a semantic execution objective associated with the parent semantic object 510. The context block 512 defines execution-relevant metadata used for localized policy evaluation. The memory field 513 stores execution history associated with the parent semantic object 510.

An arrow 501 represents initiation of a delegation event 520 by the parent semantic object 510. The delegation event 520 represents a decision by the parent semantic object 510 to decompose, parallelize, or specialize its execution objective.

Arrows 502 and 503 represent instantiation of subordinate semantic objects 530a and 530b, respectively, as a result of the delegation event 520. Each subordinate semantic object 530 executes independently while maintaining lineage association with the parent semantic object 510.

The subordinate semantic object 530a comprises an intent field 531a, a context block 532a, and a memory field 533a. The subordinate semantic object 530b comprises an intent field 531b, a context block 532b, and a memory field 533b. Each subordinate semantic object inherits execution context sufficient to preserve semantic continuity without duplicating the execution history stored in the parent memory field 513.

An arrow 504 represents generation of an execution outcome 540a by the subordinate semantic object 530a. An arrow 505 represents generation of an execution outcome 540b by the subordinate semantic object 530b. Each execution outcome 540 records execution results produced during independent execution of the subordinate semantic objects.

Arrows 506 and 507 represent propagation of execution outcomes 540a and 540b, respectively, toward aggregation. An arrow 508 represents creation of an aggregated lineage entry 550 derived from the execution outcomes 540a and 540b. The aggregated lineage entry 550 records execution results, lineage associations, and execution context for incorporation into the parent semantic object.

An arrow 509 represents appending of the aggregated lineage entry 550 to the memory field 513 of the parent semantic object 510. The parent semantic object 510 thereby incorporates results generated by subordinate semantic objects into its execution history.

Compositional execution may occur recursively. A subordinate semantic object may itself initiate additional delegation events, resulting in deeper execution graphs while preserving lineage through memory-linked references. Execution proceeds without centralized orchestration, with coordination emerging from memory-resident execution state and lineage tracking embedded within semantic objects.

The compositional execution graph 500 enables distributed problem decomposition, parallel execution, and long-horizon execution behavior while maintaining auditability and execution continuity. Execution behavior remains policy-bound and memory-resident across all levels of delegation.

### 5. Environmental Feedback, Execution Outcomes, and Reentry Logic

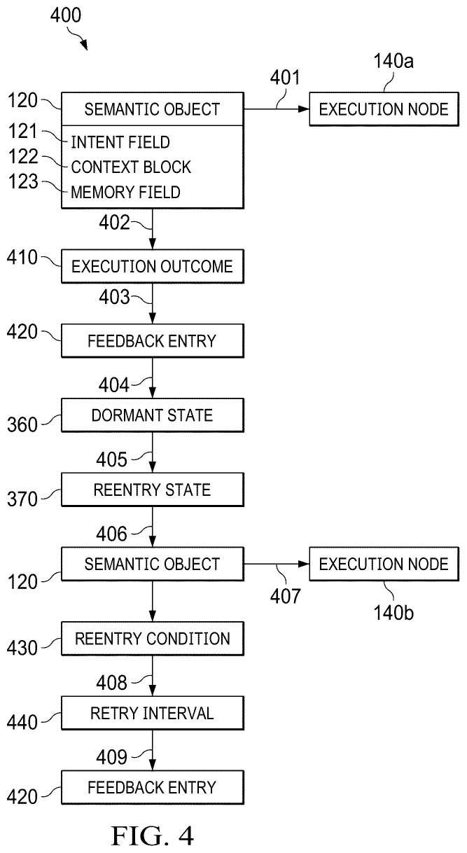

FIG. 4 illustrates adaptive execution behavior 400 in accordance with an embodiment of the present disclosure. The adaptive execution behavior 400 describes how a semantic object 120 incorporates execution outcomes into its memory field 123 and transitions through dormancy and reentry prior to subsequent execution at a different execution node.

The semantic object 120 comprises an intent field 121, a context block 122, and a memory field 123. An arrow 401 represents propagation of the semantic object 120 to an execution node 140a. The execution node 140a performs an execution evaluation and execution action based on the semantic object 120.

An arrow 402 represents generation of an execution outcome 410 associated with the evaluation or execution performed at the execution node 140a. The execution outcome 410 represents an execution result produced by the execution node 140a, including success, failure, deferral, incomplete resolution, or other execution-related outcomes.

In some embodiments, execution success is not limited to full completion of an objective. Partial execution that yields intermediate results, state advancement, constraint satisfaction, or actionable information is treated as a semantically meaningful execution outcome. Such partial execution outcomes are recorded within the memory field and may influence subsequent execution behavior, including mutation, delegation, dormancy, or termination, without requiring that the original objective be fully resolved.

In some embodiments, execution outcomes indicating failure, non-completion, or repeated deferral are interpreted as negative capability signals. Such signals indicate that an execution node, trust zone, or execution context is unsuitable for satisfying the semantic object's intent under observed conditions. Negative capability signals are preserved in the memory field and may constrain future execution attempts, influence routing or delegation decisions, or justify transition to dormancy.

In some embodiments, execution outcomes include latency conditions, timeout conditions, partial execution, non-response, or execution-node failure. Such conditions are not treated solely as operational errors, but are interpreted as semantic execution signals indicative of environmental constraints, resource availability, trust conditions, or execution feasibility. For example, prolonged latency or repeated timeout outcomes may reflect transient unavailability of a required capability, network congestion, policy-induced deferral, or insufficient execution resources at a given execution node.

In such embodiments, latency-related or failure-related execution outcomes are recorded as structured execution signals within the memory field of the semantic object. These execution signals may include quantitative timing measurements, retry counts, failure classifications, or node-specific indicators. By recording latency and failure information as semantic input, the semantic object adapts future execution behavior based on observed environmental conditions rather than treating such conditions as opaque errors.

An arrow 403 represents creation of a feedback entry 420 derived from the execution outcome 410. The feedback entry 420 is appended to the memory field 123 of the semantic object 120 as an execution trace element, thereby preserving an auditable record of the execution outcome 410.

An arrow 404 represents transition of the semantic object 120 into a dormant state 360 based on the feedback entry 420. The dormant state 360 represents suspension of execution for the semantic object 120 while the semantic object 120 persists with its memory field 123 intact.

In some embodiments, transition of a semantic object into a dormant state represents a deliberate execution decision rather than an error condition, failure state, or passive pause. Dormancy is selected as an execution action when execution is determined to be currently inadvisable, inefficient, unsafe, or non-optimal based on evaluation of the intent field, context block, memory field, and locally applied policy. Dormancy is semantically distinct from execution failure or termination. Failure represents an inability to complete execution under evaluated conditions, while termination represents satisfaction of a terminal condition or explicit cessation of execution. Dormancy, by contrast, represents an explicit decision to defer execution while preserving the semantic object as an active execution entity capable of future evaluation. By distinguishing dormancy from failure and termination, the semantic execution model enables execution behavior that spans extended time horizons without conflating temporary unsuitability for execution with permanent inability to execute. In such embodiments, dormancy constitutes a first-class execution state in which the semantic object intentionally suspends further execution attempts while preserving execution continuity, execution history, and eligibility for future reentry. The semantic object remains valid, addressable, and evaluable while dormant, and is not discarded, reset, or re-instantiated.

An arrow 405 represents progression from the dormant state 360 to a reentry state 370. The reentry state 370 represents resumption readiness for the semantic object 120 based on reentry criteria derived from stored execution history and current execution context.

The adaptive execution behavior 400 includes a reentry condition 430. The reentry condition 430 represents one or more criteria used to determine whether the semantic object 120 should reattempt execution. An arrow 408 represents evaluation of the reentry condition 430 in relation to the reentry state 370. As illustrated in FIG. 4, the reentry condition 430 is determined based on execution-state information encoded within the semantic object 120, including one or more of the memory field 123, context block 122, and prior feedback entries 420. In some embodiments, the reentry condition 430 is explicitly represented as an object-resident condition stored within the semantic object 120. In other embodiments, the reentry condition 430 is computed by an execution node 140b by evaluating object-resident execution history and policy-governed criteria, without reliance on external orchestration or centralized state.

The adaptive execution behavior 400 further includes a retry interval 440. The retry interval 440 represents an execution delay parameter used to govern timing of subsequent execution attempts. An arrow 409 represents derivation or adjustment of the retry interval 440 based on the feedback entry 420.

In some embodiments, retry behavior is governed by semantic backoff rather than fixed or exponential timing functions. Semantic backoff adjusts execution pacing based on execution outcomes recorded in the memory field, such as partial success, negative capability signals, or policy constraints, rather than applying uniform retry intervals independent of execution context.

In some embodiments, reentry conditions and retry intervals are derived in part from latency or failure patterns recorded in the memory field. For example, repeated latency beyond a threshold duration may cause the semantic object to extend a retry interval, transition into a dormant state, or redirect execution toward an alternative execution node. Conversely, improvement in observed latency conditions or recovery from failure states may satisfy reentry criteria and trigger resumption of execution. By treating latency and failure patterns as semantic execution signals, the semantic object reasons about when execution should occur, where execution is likely to succeed, and whether execution should be deferred, without reliance on external monitoring systems or centralized schedulers.

An arrow 406 represents transition from the reentry state 370 to a subsequent active semantic object 120 state. An arrow 407 represents propagation of the semantic object 120 to an execution node 140b following reentry. The execution node 140b performs subsequent evaluation and execution actions based on the semantic object 120 and its memory field 123 as modified by the feedback entry 420.

The feedback entry 420 may be appended iteratively. An arrow 409 represents creation or modification of a feedback entry 420 based on the retry interval 440, thereby recording retry timing information within the memory field 123. The semantic object 120 thereby maintains execution continuity across multiple execution attempts and across heterogeneous execution nodes through memory-resident recording of execution outcomes and reentry behavior.

### 6. Policy-bound Execution and Decentralized Evaluation

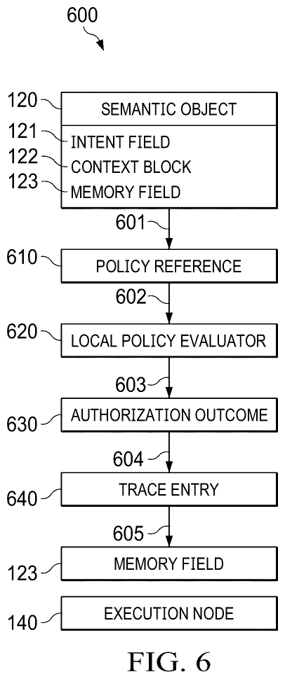

FIG. 6 illustrates policy-bound execution and local evaluation 600 in accordance with an embodiment of the present disclosure. The policy-bound execution model enables execution decisions to be determined locally at execution nodes based on policy information embedded within a semantic object rather than through centralized authorization infrastructure.

A semantic object 120 comprises an intent field 121, a context block 122, and a memory field 123. An arrow 601 represents provision of the semantic object 120 to an execution node 140 for evaluation. The execution node 140 performs execution-related evaluation based on information carried within the semantic object 120.

The semantic object 120 includes one or more policy references 610. A policy reference 610 represents policy metadata governing execution behavior, mutation eligibility, trust scope, or execution constraints associated with the semantic object 120. An arrow 602 represents evaluation of the policy reference 610 by a local policy evaluator 620.

The local policy evaluator 620 applies locally available policy logic to interpret the policy reference 610 in view of execution context at the execution node 140. Policy evaluation is performed independently by each execution node and does not rely on centralized authorization servers, shared registries, or global trust authorities.

In some embodiments, authorization outcomes reflect evaluation of multiple authority sources, including embedded policy references, execution context, and execution history preserved within the memory field. Such authority sources are evaluated independently of cognition and execution, and their combined effect is recorded as an authorization outcome without prescribing how execution must be performed.

In some embodiments, policy evaluation incorporates latency and failure information recorded in the memory field of the semantic object. For example, policy logic may interpret repeated execution failures, excessive latency, or incomplete execution outcomes as indicators of trust degradation, capability insufficiency, or environmental incompatibility. Based on such interpretation, a policy evaluator may restrict execution behavior, trigger semantic mutation, limit delegation, or require execution at a different trust zone or execution node. By embedding latency-and failure-aware signals within the semantic object, policy-bound execution decisions reflect observed execution reality rather than static assumptions about node availability or reliability.

An arrow 603 represents generation of an authorization outcome 630 based on evaluation performed by the local policy evaluator 620. The authorization outcome 630 represents a decision to permit execution, defer execution, restrict execution behavior, initiate mutation, or reject execution of the semantic object 120.

Policy evaluation functions exclusively as an authorization mechanism and does not itself perform execution actions. An authorization outcome may permit, constrain, defer, or prohibit execution, but does not directly modify the semantic object. Execution actions are applied only after authorization outcomes are recorded and interpreted by execution logic operating on the semantic object. By separating authority from execution, the semantic execution model ensures that governance decisions are enforceable without embedding execution logic within policy evaluators, thereby preserving modularity, auditability, and trust separation across distributed execution environments.

In some embodiments, policy evaluation explicitly authorizes transition of a semantic object into a dormant state. Such authorization may occur when policy conditions indicate that execution should be delayed pending satisfaction of temporal, trust, capability, safety, or contextual prerequisites. Dormancy may be mandated by policy, selected as a preferred execution action, or imposed as a constraint on execution behavior. Policy-governed dormancy enables execution control without rejecting the semantic object, revoking its intent, or discarding accumulated execution history. Instead, execution eligibility is preserved while execution timing is intentionally deferred.

An arrow 604 represents creation of a trace entry 640 corresponding to the authorization outcome 630. The trace entry 640 records the decision reached by the local policy evaluator 620, the policy reference 610 evaluated, and the execution context under which the decision was made.

An arrow 605 represents appending of the trace entry 640 to the memory field 123 of the semantic object 120. The memory field 123 thereby accumulates a persistent record of policy evaluation outcomes encountered during execution across multiple execution nodes.

Policy-bound execution does not operate as a binary access control mechanism. In some embodiments, the authorization outcome 630 may permit execution while imposing execution constraints, triggering semantic mutation, or limiting delegation behavior. In other embodiments, execution may be deferred or redirected based on locally evaluated trust or policy conditions.

Because policy evaluation is embedded within execution behavior, different execution nodes may reach different authorization outcomes when evaluating the same semantic object 120. Each outcome is recorded as a trace entry 640, preserving an auditable execution history that reflects heterogeneous policy environments.

By embedding policy references directly within the semantic object 120 and recording authorization outcomes within the memory field 123, the semantic execution model enables decentralized, trust-scoped execution without reliance on centralized access control systems. Execution behavior remains adaptive, auditable, and enforceable across distributed and heterogeneous environments.

### 7. Persistent Queries and Autonomous Polling Behavior

The semantic execution model supports persistent semantic objects capable of autonomous polling, deferred execution, and self-termination based on evolving execution conditions. Unlike conventional queries that are discarded after a single execution cycle, a semantic object may persist across extended time intervals while retaining execution continuity through its memory field.

A semantic object may enter a dormant execution state when execution conditions are unmet, incomplete, or temporarily unsatisfiable. Dormancy allows the semantic object to suspend execution without loss of execution history, intent context, or policy alignment. The semantic object remains intact as a memory-resident execution entity while dormant.

In some embodiments, dormancy is employed as an execution strategy to reduce unnecessary computation, network utilization, or resource consumption. A semantic object may intentionally enter dormancy when execution conditions are unlikely to improve in the near term, when repeated execution attempts would be wasteful, or when execution is dependent on external state changes outside the control of the execution node. Unlike conventional polling mechanisms or scheduled retries, dormancy enables the semantic object itself to govern execution pacing based on accumulated execution history and semantic interpretation of execution conditions.

Polling behavior is implemented through periodic or condition-based evaluation of reentry criteria derived from the memory field and context block of the semantic object. Reentry criteria may include elapsed time, accumulated execution outcomes, satisfaction of prerequisite conditions, or changes in execution context observed by an execution node. Polling does not require global scheduling, persistent connections, or centralized orchestration.

Execution nodes that encounter a dormant semantic object may evaluate reentry conditions locally. If reentry conditions are satisfied, the semantic object transitions back into an active execution state and resumes execution using its retained memory field. Each reentry attempt is recorded as an execution trace, preserving an auditable history of polling behavior and execution continuity.

In some embodiments, dormancy is associated with one or more explicit wake triggers recorded within the memory field. Wake triggers may correspond to elapsed time, accumulation of execution outcomes, changes in execution context, satisfaction of prerequisite conditions, or externally observed events. The semantic object remains dormant until a wake trigger is satisfied, at which point reentry evaluation may occur without centralized scheduling or external notification mechanisms.

Dormancy is semantically distinct from abandonment. A dormant semantic object retains execution intent, execution history, and eligibility for future execution, whereas an abandoned semantic object is no longer considered eligible for execution and is not expected to reenter an active execution state. Abandonment may occur as a result of explicit termination, satisfaction of a terminal condition, or policy-based cessation, and is recorded as such within the memory field.

Polling behavior may repeat across multiple execution cycles. A semantic object may alternate between active execution and dormancy multiple times as execution conditions evolve. This repeated evaluation enables the semantic object to track unresolved conditions, delayed data availability, or deferred policy satisfaction over long horizons.

A semantic object may self-terminate when a terminal condition is satisfied. Terminal conditions may include successful completion of the semantic objective, expiration of execution constraints, policy-defined cutoffs, or accumulation of failure outcomes beyond an acceptable threshold. Upon termination, the semantic object retains its final execution history within the memory field and ceases further execution.

Persistent polling behavior enables semantic execution across asynchronous and intermittently available environments. Execution continuity is maintained without maintaining open connections, synchronized clocks, or centralized schedulers. The semantic object remains a self-governing execution entity capable of autonomously determining when to act, defer, resume, or terminate based on memory-resident execution state.

By supporting persistent execution and autonomous polling, the semantic execution layer enables long-horizon execution scenarios including delayed coordination, asynchronous dependency resolution, and time-distributed semantic reasoning. This behavior differentiates semantic execution from ephemeral query models by allowing execution to persist, adapt, and conclude autonomously within distributed computing systems.

### 8. Goal Propagation in Multi-Agent Semantic Execution Systems

The semantic execution layer enables goal propagation across multiple semantic objects operating concurrently within shared or intersecting execution environments. In multi-agent configurations, each semantic object functions as an autonomous execution entity capable of expressing intent, evaluating policy, mutating execution behavior, and delegating subordinate objectives while retaining memory-resident execution lineage.

Goal propagation occurs when a semantic object initiates delegation of a portion of its execution objective to one or more additional semantic objects. The delegated semantic objects inherit relevant execution context, policy references, and lineage metadata sufficient to preserve semantic continuity while independently evaluating and executing their respective objectives. The originating semantic object remains active as a coordinating execution entity and evaluates returned execution outcomes recorded within its memory field.

Delegated semantic objects may operate asynchronously and across heterogeneous execution nodes. Each delegated object progresses through its own execution lifecycle and appends execution outcomes, mutation records, and policy decisions to its own memory field. Returned execution traces are incorporated into the memory field of the originating semantic object as lineage-linked records, enabling aggregation, comparison, and refinement of execution behavior.

Goal propagation may occur recursively. A delegated semantic object may itself initiate further delegation based on execution conditions encountered during its execution lifecycle. This recursive delegation results in a distributed execution graph composed of independently executing semantic objects linked through memory-resident lineage references. Execution coherence is preserved through shared lineage and accumulated execution history rather than through centralized coordination.

Execution decisions within multi-agent configurations are made locally by each semantic object based on its embedded intent, context, memory field, and locally evaluated policy. Despite local autonomy, the distributed execution graph collectively advances a broader semantic objective through coordinated delegation, mutation, and aggregation of execution outcomes.

The semantic execution layer does not require shared global state, synchronized execution schedules, or centralized task orchestration to support multi-agent goal propagation. Instead, coordination emerges from memory-resident execution state and policy-bound delegation behavior. This enables distributed execution across trust-divergent environments while preserving auditability, execution continuity, and semantic alignment.

By enabling goal propagation through recursive delegation and lineage-linked execution history, the semantic execution layer supports distributed reasoning, parallel execution, and collaborative task refinement across multiple autonomous semantic objects. Multi-agent execution behavior arises naturally from the execution semantics disclosed herein without introducing additional orchestration infrastructure or execution primitives.

### 9. Semantic Execution for Probabilistic Inference Engine Orchestration and Memory Integration

The semantic execution model supports orchestration of probabilistic-inference-engine- based execution nodes by treating each engine as an execution participant within the distributed execution environment. In such configurations, semantic objects operate as persistent carriers of execution intent, context, policy references, and memory across interactions with one or more engines.

A semantic object may be propagated to an probabilistic inference engine execution node for evaluation or execution. The engine interprets the semantic object based on its embedded intent, context, and accumulated execution history, and produces an execution outcome. The execution outcome may include refinement of the semantic objective, generation of candidate responses, classification results, or other execution-relevant outputs.

Execution outcomes produced by a probabilistic inference engine execution node are recorded as memory entries within the semantic object's memory field. Recorded information may include outcome descriptors, confidence indicators, refinement justifications, or other execution metadata sufficient to preserve semantic continuity and auditability. The semantic object thereby retains execution history across probabilistic inference engine interactions.

Semantic execution enables orchestration across probabilistic inference engine execution nodes without centralized coordination. A semantic object may encounter incomplete, ambiguous, or unsatisfactory execution outcomes and may respond by refining its intent, delegating sub-objectives, deferring execution, or propagating to alternate execution nodes. These behaviors are governed by the same execution semantics described in preceding sections and do not require model-specific orchestration logic.

Memory-resident execution allows semantic objects to preserve long-horizon context across probabilistic inference engine interactions. Rather than treating each interaction as a stateless prompt-response exchange, the semantic object accumulates execution history that informs subsequent execution decisions. This enables iterative refinement, multi-stage reasoning workflows, and policy-compliant execution across asynchronous interactions with probabilistic inference engine execution nodes.

Probabilistic inference engine execution nodes may differ in capability, trust scope, or policy constraints. Each execution node independently evaluates the semantic object and records execution outcomes within the semantic object's memory field. As a result, the semantic object may adapt its execution behavior based on historical outcomes encountered across heterogeneous probabilistic inference engine environments.

Semantic execution does not require direct coordination between probabilistic inference engines. Coordination emerges through memory-resident execution state, lineage tracking, and policy-bound mutation behavior embedded within the semantic object. This allows distributed orchestration of probabilistic inference engine execution while preserving auditability, trust-scoped behavior, and execution continuity.

By treating probabilistic inference engines as execution nodes within a memory-native execution framework, the semantic execution layer enables distributed, persistent, and adaptive orchestration of probabilistic inference engine-based computation without reliance on centralized controllers, stateless prompt chaining, or externally maintained execution graphs.

### 10. Swarm-based Semantic Execution and Distributed Planning

The semantic execution model supports the emergence of swarm-based execution behavior when multiple semantic objects operate concurrently within shared or intersecting execution environments. Swarm-based execution refers to distributed execution behavior in which autonomous semantic objects collectively pursue related objectives through delegation, mutation, and lineage-based coordination without centralized control.

In swarm-based configurations, each semantic object functions as an independent execution entity governed by its embedded intent, context, memory field, and locally evaluated policy. Semantic objects may initiate delegation events, refine execution objectives, enter dormancy, or resume execution based on accumulated execution history and environmental feedback. These behaviors occur independently at each semantic object while contributing to broader execution outcomes through lineage-linked aggregation.

Swarm behavior emerges when semantic objects align execution objectives through recursive delegation and memory-resident lineage tracking. Execution outcomes produced by individual semantic objects are recorded within their respective memory fields and may be incorporated into the execution history of other semantic objects through delegation relationships. This enables distributed planning and coordination without shared global state or centralized orchestration.

Distributed planning within swarm-based execution arises from iterative refinement of execution objectives across multiple semantic objects. A semantic object may evaluate execution outcomes generated by related objects and adjust its own execution behavior accordingly. Such adjustments may include refinement of intent, modification of delegation strategy, deferral of execution, or termination. Planning emerges as an execution-time phenomenon driven by accumulated memory and policy-bound evaluation rather than precomputed workflows.

Swarm-based execution may occur across heterogeneous execution nodes and trust domains. Each execution node independently evaluates semantic objects based on locally applied policy and execution context. As a result, swarm behavior may adapt dynamically to trust boundaries, policy constraints, and environmental conditions encountered during execution.

The semantic execution layer does not impose explicit coordination protocols or consensus mechanisms to achieve swarm behavior. Coordination arises implicitly through memory-resident execution state, lineage references, and repeated local evaluation of execution outcomes. This enables scalable execution across decentralized environments while preserving auditability, execution continuity, and policy compliance.

By enabling swarm-based execution through autonomous semantic objects, the semantic execution layer supports distributed problem solving, parallel execution, and adaptive planning across large-scale execution environments. Swarm behavior emerges naturally from the execution semantics disclosed herein without requiring additional orchestration infrastructure or specialized swarm control systems.

### 11. Deployment Configurations and Execution Modalities

The semantic execution layer is designed for flexible deployment across a wide range of computing environments without modification to its core execution semantics. Because semantic objects are self-contained, memory-bearing execution entities, execution behavior remains consistent regardless of infrastructure topology, connectivity model, or administrative domain.

In stateless execution environments, execution nodes operate without retaining persistent external state associated with semantic objects. Execution decisions, policy evaluation, mutation behavior, and trace recording are derived entirely from information embedded within the semantic object itself. Stateless execution nodes may evaluate semantic objects independently and append execution outcomes to the memory field before propagating or storing the semantic object for subsequent execution.

In memory-aware execution environments, such as disclosed in U.S. Nonprovisional application Ser. No. 19/366,760, titled “Cognition-Compatible Network Substrate and Memory-Native Protocol Stack”, filed Oct. 23, 2025, execution nodes may maintain local memory structures derived from previously encountered semantic objects. Such memory structures may include cached execution outcomes, lineage references, policy evaluations, or trust-related metadata. Memory-aware execution does not alter the execution semantics of the semantic object and serves only to optimize evaluation, reentry determination, or execution efficiency.

In federated execution environments, semantic objects propagate across multiple administrative or trust domains. Each domain independently evaluates semantic objects based on locally applied policy and execution context. Execution outcomes generated within one domain are preserved within the memory field of the semantic object and may be evaluated by execution nodes in other domains without requiring synchronized control or shared authorization infrastructure.

In edge-oriented execution environments, semantic objects may be evaluated by resource-constrained execution nodes operating intermittently or asynchronously. Because execution state is carried within the semantic object, execution continuity is preserved despite limited connectivity, intermittent availability, or constrained compute resources. Execution nodes may defer execution, enter dormancy, or initiate reentry behavior based on locally evaluated conditions.

In agent-based execution environments, semantic objects may be embedded within autonomous systems, simulations, or distributed control frameworks. Each semantic object operates as a mobile execution entity capable of carrying intent, context, policy references, and execution history into its operational environment. Coordination between semantic objects arises from delegation, lineage tracking, and memory-resident execution state rather than from centralized control mechanisms.

Across all deployment configurations, the semantic execution layer preserves execution continuity, policy-bound behavior, and auditability through memory-resident execution state. Execution semantics remain invariant across deployment modalities, enabling the semantic execution layer to function as a foundational execution model adaptable to diverse computing environments without requiring redesign or reconfiguration.

### 12. Definitions

As used herein, the term “semantic object” refers to a structured, memory-bearing computational object that encodes intent, context, and execution-relevant state, and that may exist independently of any active execution, including in a dormant, serialized, pre-instantiated, or terminated form.

As used herein, the term “semantic agent” refers to a semantic object described with respect to autonomous behavior, goal pursuit, delegation, or adaptive decision-making, without requiring that the semantic object be actively executing.

As used herein, the term “persistent executable object” refers to a semantic object when the semantic object is subject to an execution lifecycle in which the semantic object is evaluated, acted upon, mutated, delegated, placed into dormancy, reentered, or terminated by one or more execution nodes, such that execution continuity is governed by object-resident state without centralized coordination. It is noted that when a semantic object or semantic agent is described herein as being evaluated, executed, propagated, mutated, delegated, placed into dormancy, reentered, or otherwise participating in execution behavior, the semantic object or semantic agent is operating as a persistent executable object, regardless of whether the term “persistent executable object” is expressly used in that context.

As used herein, the term “intent field” refers to a structured, machine-parseable data structure embedded within a semantic object that encodes one or more execution directives or descriptors, constraints, or objectives interpretable by an execution node, wherein the intent field may be modified during execution based on execution outcomes or policy evaluation.

As used herein, the term “context block” refers to identity-and execution-related and trust-scoped metadata embedded within a semantic object, the context block defining execution-relevant attributes used for localized policy evaluation during execution.

As used herein, the term “memory field” refers to a structured data region embedded within a semantic object that records execution history, including execution traces, mutation records, delegation references, policy references, and reentry information, thereby enabling execution continuity and auditability across asynchronous execution cycles.

As used herein, the term “memory entry” refers to an individual record appended to the memory field of a semantic object that captures a discrete execution-related event occurring during execution of the semantic object.

As used herein, the term “mutation event” refers to a controlled modification of one or more execution-relevant attributes of a semantic object, including modification of the intent field, context block, or memory field, performed during execution and recorded in the memory field to preserve execution lineage. Mutation events are constrained by the structural schema of the semantic object and applicable policy references, and do not permit arbitrary modification of execution state outside defined execution-relevant attributes.

As used herein, the term “delegation” refers to an execution behavior in which a semantic object initiates one or more subordinate semantic objects to pursue related or subordinate execution objectives while preserving execution lineage through memory-linked references.

As used herein, the term “subordinate semantic object” refers to a semantic object instantiated as a result of delegation by another semantic object, the subordinate semantic object executing independently while maintaining lineage association with the originating semantic object.

As used herein, the term “execution trace” or “trace outcome” refers to a verifiable record of an execution-related event or outcome appended to the memory field of a semantic object, the execution trace recording execution decisions, authorization outcomes, mutation events, dormancy transitions, reentry attempts, or termination conditions.

As used herein, the term “reentry” refers to resumption of execution by a semantic object following a dormant state when one or more reentry conditions are satisfied based on execution history, elapsed time, or policy evaluation.

As used herein, the term “polling behavior” refers to execution behavior in which a semantic object repeatedly evaluates reentry conditions over time while in a dormant state without requiring continuous execution or centralized scheduling.

As used herein, the term “lineage” refers to an execution relationship between semantic objects established through delegation and recorded within memory fields, enabling aggregation of execution outcomes and auditability across distributed execution.

As used herein, the term “semantic chaining” refers to compositional execution behavior in which multiple semantic objects are linked through lineage and memory references to form multi-step execution pathways or long-horizon execution workflows.

As used herein, the term “semantic swarm” refers to a collection of semantic objects operating concurrently within shared or intersecting execution environments, wherein coordinated execution behavior emerges through delegation, mutation, lineage tracking, and memory-resident execution state without centralized control.

As used herein, the term “policy reference” refers to policy metadata embedded within a semantic object that governs execution behavior, mutation eligibility, delegation constraints, or trust scope evaluation, the policy reference being evaluated locally by execution nodes during execution.

As used herein, the term “execution node” refers to a computing system, process, or execution environment capable of evaluating a semantic object and performing execution actions based on information embedded within the semantic object.

As used herein, “execution outcome” includes not only completion or failure of execution, but also latency, timeout, partial execution, non-response, or environmental conditions observed during execution. Such outcomes are treated as semantic execution signals when recorded within the memory field and may influence subsequent execution evaluation, policy interpretation, mutation behavior, dormancy, or reentry.

As used herein, “dormant state” refers to an intentional execution state in which a semantic object suspends active execution while remaining valid, memory-resident, and eligible for future evaluation and reentry. Dormancy is selected as an execution action based on evaluation of execution conditions and is distinct from failure, termination, or inactivity.

As used herein, “cognition” refers to reasoning, inference, interpretation, or recommendation processes applied to information carried by a semantic object, without authority to modify execution state.

As used herein, “authority” refers to policy, governance, or trust evaluation processes that determine whether execution actions are permitted, constrained, deferred, or prohibited.

As used herein, “execution” refers to application of authorized state transformations to a semantic object, including mutation, delegation, dormancy, reentry, or termination, as recorded within the memory field.

As used herein, the term “semantic,” when applied to data structures, execution objectives, or execution behavior, refers to machine-interpretable meaning encoded in structured, parseable representations carried by a semantic object, and does not refer to human language understanding, subjective interpretation, or natural-language meaning. A semantic object or semantic agent is therefore a machine-executable object.

As used herein, the phrase “without centralized coordination” refers to an execution model in which execution decisions, action selection, and execution-state progression are determined locally and independently by each execution node based solely on information contained within the persistent execution object and locally applicable execution conditions.

For purposes of this disclosure, “centralized coordination” encompasses centralized control, centralized scheduling, centralized orchestration, and any equivalent execution governance mechanism in which a global authority external to the persistent execution object governs execution sequencing, state progression, or action eligibility.

Accordingly, execution without centralized coordination is performed without reliance on: (i) a centralized scheduler, controller, orchestrator, workflow engine, master node, or global execution authority; (ii) a shared global execution state maintained outside the persistent execution object; (iii) a required consensus protocol, global lock, or synchronous agreement among execution nodes prior to execution; or (iv) an externally imposed execution order or coordination signal not derivable from the persistent execution object itself. The absence of centralized coordination does not preclude distributed communication, eventual consistency, policy validation, or independent verification by other execution nodes, provided that no single centralized authority governs execution sequencing or execution-state progression.

What is claimed is:

1. A computer-implemented method for executing semantic object-resident computation in a distributed computing system, the method comprising:
instantiating a persistent executable object stored in non-transitory memory, the persistent executable object comprising an intent field encoding a machine-readable execution descriptor, a context block encoding execution-relevant metadata, and a memory field encoding prior execution state;
propagating the persistent executable object among a plurality of execution nodes of the distributed computing system;
at each execution node that receives the persistent executable object, performing an execution evaluation cycle comprising:
parsing the intent field to identify an execution operation expressed by the machine-readable execution descriptor;
evaluating the context block against locally applicable execution policy without reliance on centralized coordination;
reading the memory field to retrieve one or more prior execution records stored by a previous execution evaluation cycle; and
selecting, based solely on the parsed intent field, the evaluated context block, and the retrieved prior execution records, an execution action selected from the group consisting of execution, mutation, delegation, dormancy, reentry, and termination;
executing the selected execution action; and
recording an execution outcome corresponding to the selected execution action by appending a new execution record to the memory field of the persistent executable object, wherein execution continuity across multiple execution lifecycles is maintained by the memory field of the persistent executable object.

2. The method of claim 1, wherein the persistent executable object persists across asynchronous execution intervals and resumes execution without re-instantiation based on one or more reentry conditions encoded in the memory field.

3. The method of claim 1, wherein the persistent executable object transitions into a dormant state when execution conditions encoded in the context block or memory field are unmet and subsequently transitions to a reentry state upon satisfaction of a reentry condition recorded in the memory field.

4. The method of claim 1, wherein mutation comprises modifying at least one of the intent field, the context block, or the memory field of the persistent executable object in response to an execution outcome.

5. The method of claim 4, wherein each mutation is recorded as a distinct memory record in the memory field, thereby preserving execution lineage of the persistent executable object.

6. The method of claim 1, wherein delegation comprises instantiating one or more subordinate executable objects derived from the persistent executable object.

7. The method of claim 6, wherein execution outcomes generated by one or more subordinate execution objects are aggregated into the memory field of the persistent execution object.

8. The method of claim 1, further including forming a distributed execution graph defined by object-resident lineage references stored in respective memory fields from a plurality of persistent executable objects.

9. The method of claim 1, wherein evaluation of locally applicable execution policy is performed using one or more policy references encoded within the persistent executable object.

10. The method of claim 9, wherein different execution nodes select different execution actions for the same persistent executable object based on locally applicable execution policy while preserving execution continuity through the memory field.

11. The method of claim 1, further including reusing a previously executed persistent executable object to fulfill a new execution operation when execution history stored in the memory field and metadata stored in the context block satisfy local evaluation criteria.

12. The method of claim 1, wherein at least one execution node comprises a probabilistic inference engine configured to generate a recommended execution action for the persistent executable object, wherein the recommended execution action is recorded as an execution outcome in the memory field without computing a performance state or controlling access to a system capability.

13. The method of claim 1, wherein multiple persistent executable objects operate concurrently and coordinate execution through object-resident delegation, mutation, and lineage tracking without centralized control.

14. The method of claim 1, wherein the persistent executable object self-terminates upon satisfaction of a terminal condition recorded in the memory field.

15. The method of claim 1, wherein the execution node does not store execution progress, execution eligibility, or execution history for the persistent executable object outside the memory field of the persistent executable object.

16. The method of claim 1, wherein the persistent executable object is serialized for propagation between execution nodes and deserialized prior to each execution evaluation cycle, such that execution continuity is preserved independently of execution node identity.

17. The method of claim 1, wherein the memory field is append-only and prior execution records are not overwritten during mutation, delegation, or termination.

18. The method of claim 1, wherein execution outcomes include partial execution results and negative capability signals recorded in the memory field, and further including using the execution outcomes to govern subsequent execution behavior.

19. A non-transitory computer-readable medium storing instructions that, when executed by one or more processors, cause the processors to perform the method of claim 1.

20. A distributed computing system, comprising:
a plurality of execution nodes; and
a persistent execution object configured to propagate among the execution nodes, the persistent execution object comprising:
an intent field encoding a machine-readable execution descriptor;
a context block encoding execution-relevant metadata; and
a memory field storing an append-only execution history,
wherein each execution node is configured to:
parse the intent field, evaluate the context block, and read the memory field;
select an execution action as a function of data stored within the intent field, the context block, and the memory field without centralized coordination; and
append an execution outcome corresponding to the selected execution action to the memory field,
such that execution continuity of the persistent executable object is preserved by an object-resident execution state.
